(19) United States
(12) Patent Application Publication
(10) Pub. No.: US 2002/0000736 A1
(43) Pub. Date: Jan. 3, 2002

(54) HORIZONTAL POSITIONING OF DUMP TRUCK TAILGATE

(76) Inventor: TOM MUSSO, BATH, NY (US)

Correspondence Address: ALIX YALE & RISTAS LLP, 750 MAIN STREET, SUITE 600, HARTFORD, CT, 06103

(21) Appl. No.: 09/337,144

(22) Filed: Jun. 21, 1999

(51) Int. Cl. B62D 25/00

(52) U.S. Cl. 296/57.1

(57) ABSTRACT

A latchable hinge for securing a tailgate to a truck body. The latchable hinge comprises a strike and a plunger assembly. The strike is mounted to one of the tailgate or the body and the plunger assembly is mounted to the other. The strike defines an aperture. The plunger assembly comprises a spaced set of tabs each defining an aperture. A bolt is slidable within the tab apertures, and is biased into an extended position, but may be moved to a retracted position. In the extended position the bolt can be captured by the strike aperture, and acts as a pivot around which the strike end thereby, the tailgate can rotate. In the retracted position, the strike is free of the bolt, and the tailgate is not secured to the dump body.

### BACKGROUND OF THE INVENTION

This invention relates to a hinge for a truck body. More specifically, this invention relates to a latchable hinge for securing a tailgate to a dump truck body.

Dump trucks, especially medium and heavy duty trucks adapted for the movement of bulk construction materials, are common and well known. Commonly, this type of vehicle has a generally box shaped dump body to contain the bulk materials during transport. The vehicle also has a lift which can raise the front of the dump body with respect to the rear during unloading. This creates an inclined plane such that the bulk materials slide toward the back of the body and are dumped through an open tailgate.

The tailgate at the rear of the dump body is designed to allow the transport of bulk materials while facilitating the rapid discharge via dumping. The top of the tailgate is usually hinged to the top of the body with pins, and the bottom of the tailgate is usually releasably coupled to the bottom of the body. The result is a solid attachment of the tailgate to the body when the tailgate bottom is coupled, allowing construction materials to be transported without loss. To normally dump the construction materials, the bottom of the tailgate is uncoupled from the bottom of the dump body. The tailgate can then pivot around the top pins, creating an opening between the rear of the dump body and the bottom of the tailgate. As the front of the dump body is raised, the construction materials rapidly flow to the rear of the body and are discharged through the opening. After discharge of the bulk material, the front of the dump body is lowered, with the tailgate pivoting back to its initial position, ready for re-coupling to the dump body.

Some materials carried by the truck cannot be discharged in the normal manner, for instance, boulders too large to fit through the opening created between the tailgate and the dump body, or items too fragile to withstand the fall to the ground. For these materials, it is desirable to allow the tailgate to rotate around the bottom coupling mechanism to a horizontal or lowered vertical position. This allows a larger opening in the back of the dump body for discharging materials which can be dumped, or for carrying off fragile items.

The manipulation of the tailgate to a horizontal or lowered vertical position can present a number of problems. Conventional hinge pins, when new, require tools for removal. In the usual construction environment, the hinge pins quickly rust into place in the body, allowing the tailgate to pivot, but making removal from the body difficult, even with the use of tools. After removal, the pins are easily misplaced. Finally, after unloading of the bulk material, the tailgate must be placed back into the raised vertical position. This requires the operator to manually lift the tailgate to the raised vertical position, at the same time trying to align holes high on both sides of the body with holes in the top of the tailgate. The operator must then hammer the pins back into those holes, while maintaining everything in alignment. At best this process is difficult, and at worst it may be impossible for a single operator to achieve.

### SUMMARY OF THE INVENTION

An object of the invention is to provide a dump body hinge for a tailgate.

Another object of the invention is to provide a hinge for a dump body tailgate which is easily releasable without tools.

A further object of the invention is to provide a hinge for a dump body tailgate which can be rapidly released and reattached by a single operator.

The present invention achieves these objects by use of a latchable hinge comprising an extendable plunger assembly cooperating at right angles with a movable strike. Preferably a pair of latchable hinges is used, with one plunger assembly mounted to each side of the dump body and one strike mounted cooperatively to each side of the tailgate. It would also be possible to mount the plunger assemblies to the tailgate and the strikes to the dump body.

The plunger assembly includes a bolt biased toward an extended position. In the extended position, the bolt fits within an aperture defined by a strike. In this relationship the bolt can act as a pivot, supporting the weight of the tailgate and allowing the strike, and thereby the tailgate bottom edge, to rotate. The plunger assembly also includes a lever attached to the bolt for moving the bolt against the bias to a retracted position. In the retracted position, the bolt is free of the strike aperture and the tailgate top edge can rotate around the bottom coupling mechanism.

Preferably, the end of the bolt is beveled so that the strike can move past the extended bolt until the bolt fully engages the aperture. The plunger assembly may also comprise a guide to help align the strike with the bolt. The lever, especially if toggled, may also serve to retain the bolt in the retracted position.

An operator uses the invention by toggling the lever of a first latchable hinge on one side of the dump body, locking the bolt into the retracted position. The operator then toggles the lever of a second latchable hinge on the opposing side of the dump body, locking that bolt in the retracted position. The tailgate top edge can now be lowered by rotation around the bottom coupling mechanism. After unloading the material, the operator toggles both levers to their original position, biasing both bolts toward the extended position, and rotates the tailgate back into the raised vertical position. As the tailgate returns to this position, the strikes on each side of the tailgate, traveling in an arc around the lower coupling, move past the bevel on the bolts, until the bolts engage the strike aperture on each side, thus securing the tailgate to the dump body. The release and reattachment of the tailgate to the dump body are rapid and require no tools. Further, the bolt is automatically aligned with, and captured within, the strike aperture during reattachment, without operator attention.

### DESCRIPTION OF THE DRAWINGS

Other objects and advantages of the invention will be evident to one of ordinary skill in the art from the following detailed description made with reference to the accompanying drawings, in which:

FIG. 1 is a schematic, partially exploded view of a truck dump body, viewed from the rear, showing the tailgate and latchable hinge;

FIG. 2A is a schematic side view of the dump body of FIG. 1 showing the tailgate in the raised vertical position;

FIG. 2B is a schematic side view of the dump body of FIG. 1 showing the tailgate secured in the horizontal position;

FIG. 2C is a schematic side view of the dump body of FIG. 1 showing the tailgate in the lowered vertical position;

FIG. 3 is a partial, exploded perspective view of a single latchable hinge;

FIG. 4 is a partial top view, partly in phantom, of a single latchable hinge with the bolt in the extended position; and

FIG. 5 is a partial top view, partly in phantom, of a single latchable hinge with the bolt in the retracted position.

### DESCRIPTION OF THE PREFERRED EMBODIMENTS

In the following description of the preferred embodiments, like reference numerals represent identical or corresponding parts throughout the different views.

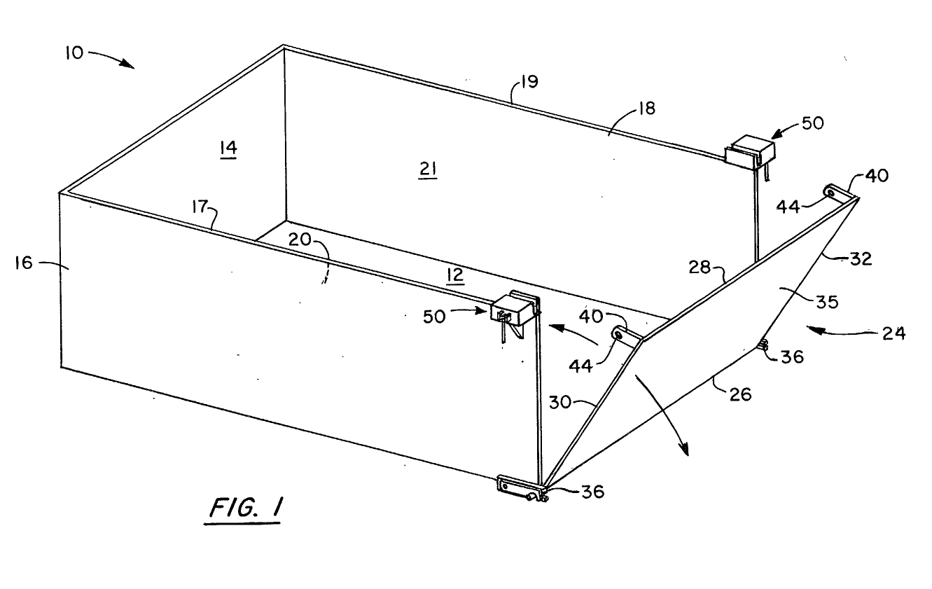

FIG. 1 shows the dump body, designated generally as 10, as seen from the rear of the truck. The dump body is generally box shaped, with an open top and rear. The dump body comprises a bed 12, a front wall 14, a first side wall 16 and a second side wall 18. The walls are connected to the bed 12. The side walls 16, 18 each have an interior face (20 and 21 respectively), facing into the dump body, an exterior face (not shown) and top edges, 17 and 19 respectively.

The tailgate 24 acts as a back wall for the dump body 10. The tailgate 24 is generally rectangularly shaped and abuts the rear opening of the dump body. The tailgate has an interior face (not shown), an exterior face 35, a bottom edge 26, a top edge 28, a first side 30 and a second side 32. The tailgate may be double walled, with the interior and exterior walls connected by the sides and edges. Alternatively, the tailgate may have a single wall with reinforcing members surrounding the periphery of the wall to create the sides and edges.

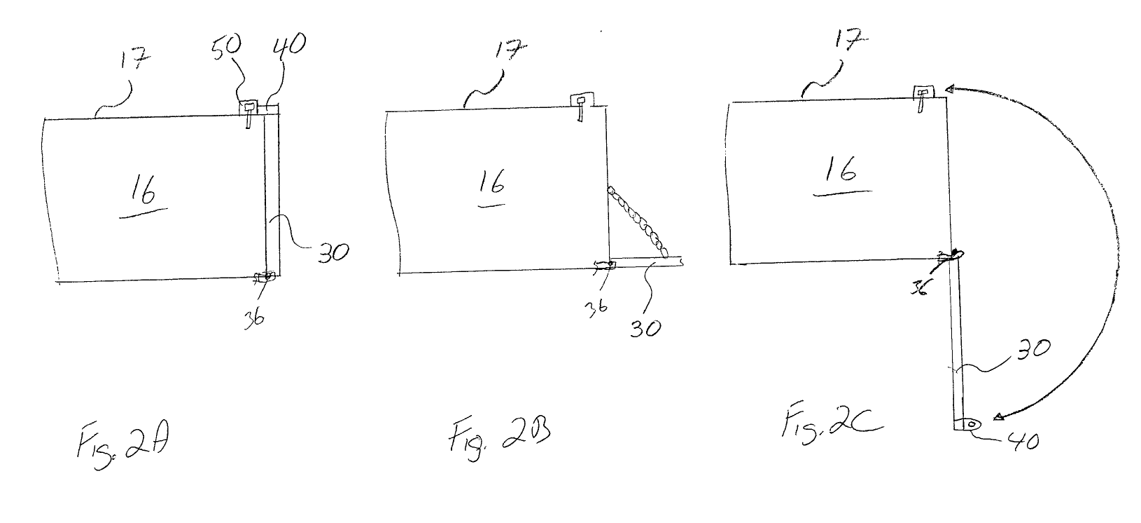

The tailgate bottom 26 is rotatably captured to the dump body 10 by a releasable coupling mechanism 36 as is commonly known in the art. When the bottom coupling mechanism is secured, the tailgate is limited to a pivotal motion, with the tailgate top edge 28 following a circular path around the lower pivot axis created by the coupling mechanism, as shown in FIGS. 2B and 2C.

The tailgate top 28 is secured to the dump body 10 by at least one latchable hinge. Preferably, a pair of latchable hinges is employed, one on each side of the tailgate. Although the use of a pair of latchable hinges is preferred, the description will generally refer to a single latchable hinge. As shown in FIG. 1, the latchable hinge comprises a strike 40 and a plunger assembly 50. The strike is mounted to either of the tailgate sides, 30 or 32, adjacent to the top edge 28. The plunger assembly is mounted to the dump body on either of the top edges, 17 or 19, adjacent to the rear of the body. While these mounting positions are preferred, other positions will also be suitable to practice the invention. As an example, the plunger assembly 50 may be mounted on the tailgate 24 and the strike 40 may be mounted on the body 10. The component mounted to the tailgate will follow the circular path of the tailgate top edge as the tailgate is raised and lowered.

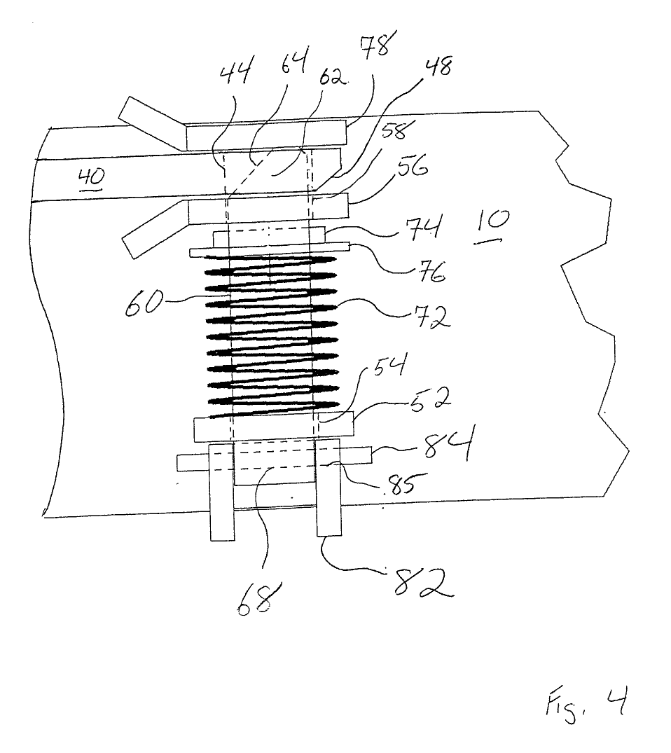

The strike 40 defines an aperture 44 parallel with the tailgate side. The plunger assembly 50 has a bolt, 60. The longitudinal axis of the bolt 60 is perpendicular to the strike aperture 44. The bolt is biased toward an extended position, shown in FIG. 4. When the tailgate is in the raised vertical position, the strike aperture 44 and bolt 60 are in axial alignment and the bolt is biased into the aperture. With the bolt 60 biased into the aperture 44, rotation of the tailgate top edge 28 around the bottom coupling mechanism 36 is prevented. The bolt 60 creates an upper pivot axis. When the bottom coupling mechanism is uncoupled, the latchable hinge possesses sufficient strength to support the weight of the tailgate, allowing the strike 40 and the attached tailgate 24, to rotate around the upper pivot axis created by the bolt 60 for normal dumping.

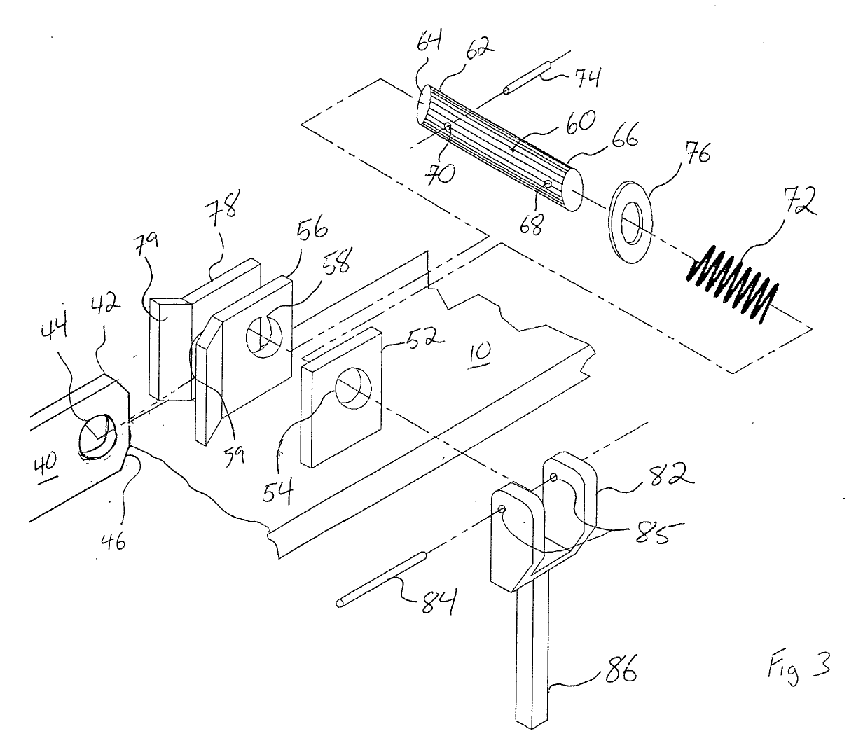

In one embodiment, shown in FIG. 1, the strike is elongated and has a first end mounted to a tailgate side, 30 or 32, adjacent to the tailgate top edge 28. The aperture 44 is defined within an opposing end, which extends beyond the inside face of the tailgate. The strike 40 may also have a bevel, 46 or 48, as shown in FIGS. 3 or 4 respectively.

It is also possible for the side of the tailgate to act as the strike, with the aperture defined within the side of the tailgate. In this embodiment the plunger assembly 50 is mounted to the dump body 10 such that the strike aperture and the bolt are in axial alignment when the tailgate is in the raised vertical position. In either embodiment, the strike and the aperture will follow a circular path as the tailgate moves from the lowered or horizontal position to the raised vertical position.

Preferably, as shown in FIG. 3, the plunger assembly 50 comprises a bias tab 52, spaced from the strike 40, and a first guide tab 56, located between the bias tab and the strike. The bias and first guide tabs each define apertures, 54 and 58 respectively, which are in coaxial alignment with the strike aperture 44 when the tailgate is in the raised vertical position. Preferably the tabs 52 and 56 are parallel to the strike 40 when the tailgate is in the raised vertical position and are mounted to the top edge, 17 or 19, of the dump body adjacent to the rear.

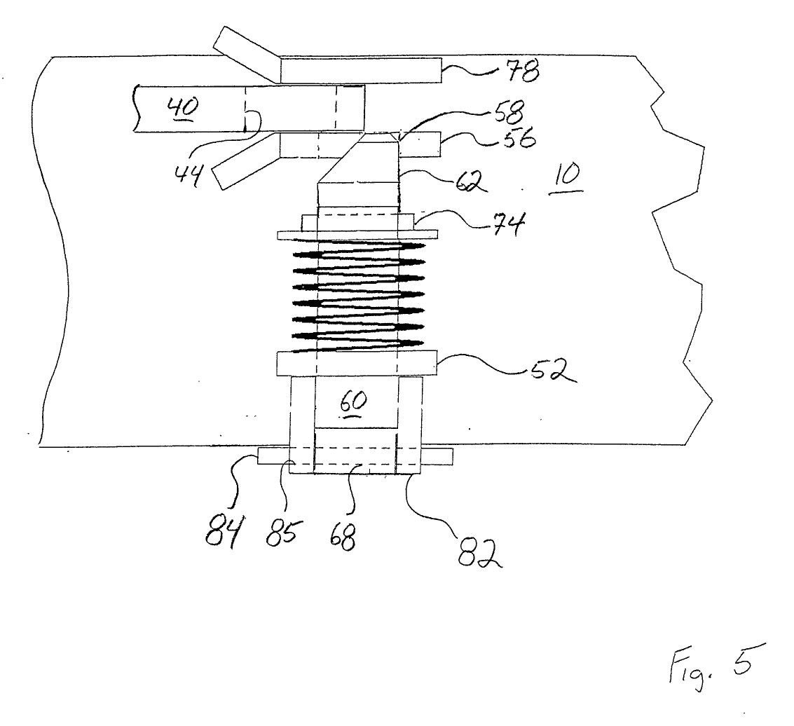

A bolt 60 is received within the bias tab and guide tab apertures 54, 58. The bolt is longitudinally displaceable between an extended position, shown in FIG. 4, and a retracted position, shown in FIG. 5. The bolt 60 has a pin end 62, extending beyond the interior face of the guide tab 56 in the extended position. The pin end 62 may have a rear facing bevel 64. In the extended position, the pin end 62 of the bolt fits within the strike aperture 44 of the raised vertical tailgate. The bolt also has an opposing actuation end 66, extending beyond the exterior face of the bias tab 52.

The bolt 60 has a spring retainer located between the bias tab 52 and first guide tab 56. In one embodiment, the spring retainer comprises a first aperture 70 transverse to the longitudinal axis of the bolt through which a pin 74 is inserted. A thrust washer 76 may also be incorporated coaxially over the bolt 60 between the pin 74 and the bias tab 52.

A spring is compressed, with one end trapped by the interior face of the bias tab 52 and the opposing end trapped by the spring retainer. The spring biases the spring retainer, and thereby the bolt pin end 62 away from the bias tab 52 and toward the extended position. In one embodiment, the spring is a coiled spring 72, surrounding and generally coaxial with the bolt 60.

A lever is mounted to the bolt 60. The lever allows an operator to move the bolt 60 from the extended position to the retracted position, thereby freeing the top edge of the tailgate from the dump body. The lever may be rigidly mounted to the bolt so that an operator can pull the lever and bolt against the bias. Alternatively, the lever may be pivotally coupled to the bolt so that the lever pushes against a surface, enhancing the leverage available for moving the coupled bolt against the bias.

In one embodiment, the lever comprises a cam attached to a handle 86. The cam is coupled to the bolt 60 and abuts the exterior face of the bias tab 52. In a further refinement, shown in FIG. 3, the cam comprises an eccentric yoke 82 with a pair of axially aligned apertures 85. The yoke 82 is coupled to the bolt 60.

The coupling of a lever or cam to the bolt may be at the bolt actuation end 66 such as at a second transverse aperture 68, located exteriorly to the bias tab 52. Preferably as shown in FIGS. 3, 4 and 5, the coupling comprises a pin 84 which rotatably connects the lever or cam to the bolt. The coupling of the lever to the transverse aperture may also be accomplished with other commonly known methods, such as bolts.

In one embodiment, the lever in a first position, shown in FIG. 4, allows the coupling 84 to remain adjacent to the exterior face of the bias tab 52, thereby allowing the bolt 60 to remain biased toward the extended position. In a second position, shown in FIG. 5, the coupling 84 and bolt 60 are moved away from the bias tab 52, drawing the bolt into the retracted position. A handle 86 (omitted from FIGS. 4 and 5) is attached to the cam so that an operator has leverage to move the cam 82, and thereby the bolt 60, from the retracted position toward the extended position and back.

Preferably, the shape of the cam allows the coupling to be toggled between the first position and the second position. In this embodiment, the bolt 60 is moved to, and retained in, the retracted position by movement of the lever. The bolt remains in the retracted position until the lever is manually returned to its original position.

In another variation, shown in FIG. 3, the plunger assembly further includes a second guide tab 78 spaced from the first guide tab 56 by the strike 40. The spacing distance is chosen so that the strike 40 can freely enter between the guide tabs 56, 78. The guide tabs can include rear facing bevels, 59 and 79, to create a funnel-shaped guide for the strike 40. In the extended position, the pin end 62 of the bolt 60 rests against the exterior face of the second guide tab.

In use of a preferred embodiment, the handle 86 is moved so that the cam 82 is toggled to the second retracted position. The cam toggling moves and retains the bolt 60 in the retracted position. In the retracted position, there is no contact between the bolt pin end 62 and the strike aperture 44, so the tailgate 24 is free to rotate around the lower pivot axis 36 to the horizontal or lowered vertical positions.

To secure the tailgate in the raised vertical position, the cam is toggled to the first position. This cam toggling allows the bolt to be biased toward the extended position. As the tailgate is rotated to the raised vertical position, the strike 40 and strike aperture 44 travel in a circular path. As the elongated end of the strike 40 approaches the plunger assembly it is guided by the beveled ends, 59 and 79, of the guide tabs 56 and 78. As the elongated end of the strike comes into contact with the bolt bevel 64, the bolt is moved against its bias and the strike slides past. When the path of the strike aperture 44 intersects the longitudinal axis of the bolt 60, the spring biases the bolt 60 into the strike aperture 44. With the bolt 60 biased into the strike aperture 44, the tailgate upper edge 28 is prevented from rotating around the lower pivot axis, although rotation of the strike 40 and thereby the tailgate 24, around the upper pivot axis created by the bolt pin end 62 is possible.

While preferred embodiments of the foregoing invention have been set forth for purposes of illustration, the foregoing description should not be deemed a limitation of the invention herein. Accordingly, various modifications, adaptations and alternatives may occur to one skilled in the art without departing from the spirit and scope of the present invention.

What is claimed:

1. A latchable hinge comprising:
a strike defining an aperture, said strike mounted to one of a dump body or a tailgate;
a bolt with a pin end, said bolt mounted to the other of the dump body or the tailgate for displacement between an extended position and a retracted position, said bolt having a bias toward the extended position wherein the bolt pin end engages the strike aperture when the tailgate is in a raised vertical position; and
means for selectively moving said bolt into the retracted position wherein the bolt pin end disengages the strike aperture when the tailgate is in a raised vertical position.

2. The latchable hinge of claim 1 wherein the strike is elongated.

3. The latchable hinge of claim 1 wherein the strike is mounted to the tailgate and the bolt is mounted to the dump body.

4. The latchable hinge of claim 1 wherein the bolt pin end has a bevel.

5. The latchable hinge of claim 1 wherein the means for moving said bolt into the retracted position further selectively retains the bolt in said retracted position.

6. The latchable hinge of claim 1 wherein the bolt and strike aperture each have a circular cross-section.

7. The latchable hinge of claim 1 further comprising,
a plunger assembly mounted to the other of the dump body or the tailgate, said plunger assembly including a bias tab spaced from a first guide tab, each tab defining an aperture in axial alignment with the strike aperture when the tailgate is in the raised vertical position; and
said bolt is displaceable through said tab apertures between the extended position and the retracted position.

8. The latchable hinge of claim 7 wherein the plunger assembly further comprises a second guide tab spaced from the first guide tab by the strike.

9. The latchable hinge of claim 8 wherein at least one guide tab has a bevel.

10. An upper latchable hinge for a dump body and a tailgate, comprising:
at least one strike defining an aperture, said strike mounted to one of the dump body or the tailgate;
at least one plunger assembly mounted to the other of the dump body or the tailgate, said plunger assembly comprising,
a bias tab and a spaced guide tab each defining an aperture axially aligned with the strike aperture when the tailgate is in a raised vertical position,
a bolt longitudinally movable within said tab apertures between an extended position and a retracted position, said bolt having a pin end, means for retaining a spring, and an actuation end,
a spring trapped between the bias tab and the spring retaining means, wherein said spring biases said bolt toward the extended position, and
a lever with a first end comprising a handle and an opposing second end, said lever mounted to said bolt;
wherein moving the handle moves said bolt between the extended position, in which the bolt pin end is captured for relative rotation within the strike aperture when the tailgate is in the raised vertical position, and the retracted position, in which the bolt pin end is withdrawn from the strike aperture.

11. The latchable hinge of claim 10, wherein the strike has a first end mounted to the tailgate and an elongated second end projecting into the dump body when the tailgate is in the raised vertical position.

12. The latchable hinge of claim 10, wherein the lever is pivotally mounted to the bolt and the lever abuts a surface.

13. The latch of claim 12, wherein the abutting surface is the guide tab or the bias tab.

14. The latch of claim 12, wherein the lever comprises a cam.

15. The latch of claim 12, wherein the lever toggles the bolt between the extended and the retracted position.

16. A tailgate latching system, comprising:
a truck body having a bed with front, first and second sides, each extending from the bed to a top edge;
a tailgate abutting the rear of the truck body, said tailgate having an upper edge, a lower edge, a first side, a second side, an interior face and an exterior face;
a pair of strikes, one strike mounted to each of the tailgate first and second sides adjacent to the upper edge, each said strike defining an aperture;
a pair of plunger assemblies, one plunger assembly mounted to each of the truck first and second sides, each said plunger assembly including,
a bias tab and a spaced guide tab, each tab defining an aperture axially aligned with the strike aperture,
a bolt coaxially movable within said tab apertures between an extended position and a retracted position, said bolt having a pin end with a rear facing bevel, a first transverse aperture between the tabs, and an actuation end with a second transverse aperture,
a coiled spring surrounding said bolt, one end trapped by the bias tab and an opposing end trapped by a pin extending through the first aperture, wherein said spring biases said bolt toward the extended position, and
a lever with a first end comprising a handle and a second end comprising an eccentric yoke, said yoke coupled to the second transverse aperture and abutting the bias tab;
wherein moving the handle rotates the eccentric yoke against the bias tab, toggling said bolt between the extended position in which the bolt pin end is rotatably captured within the strike aperture, and the retracted position in which the bolt pin end is withdrawn from the strike aperture.

17. The latching system of claim 16, wherein at least one plunger assembly further comprises a second guide tab spaced from the first guide tab by the strike, and the bolt pin end is biased toward the second guide tab.

18. The latch of claim 16, wherein at least one guide tab has a rear facing bevel.

19. The latching system of claim 16, wherein a washer is disposed coaxially over at least one bolt between the coiled spring opposing end and the pin extending through the first aperture.

20. The latching system of claim 16, wherein at least one strike further comprises a bevel.

21. The tailgate latching system of claim 1 6, wherein at least one strike has an elongated end projecting orthogonally to the tailgate interior face.
